(19) United States
(12) Patent Application Publication
(10) Pub. No.: US 2024/0069189 A1
(43) Pub. Date: Feb. 29, 2024

(54) Method for Detecting Surroundings of a Vehicle Using a Radar Sensor Based on Third-Party Radar Signals from Other Road Users, and Radar Sensor System

(71) Applicant: Bayerische Motoren Werke Aktiengesellschaft, Muenchen (DE)

(72) Inventor: Stefan HOLZKNECHT, Feldkirchen (DE)

(21) Appl. No.: 18/267,815

(22) PCT Filed: Dec. 7, 2021
(86) PCT No.: PCT/EP2021/084536

§ 371 Date: Jun. 16, 2023

(30) Foreign Application Priority Data
Dec. 18, 2020 (DE) 10 2020 134 228.4

(51) Int. Cl. G01S 13/931

(52) U.S. Cl. CPC G01S 13/931; G01S 2013/9318; G01S 2013/93272

(57) ABSTRACT

A method for detecting surroundings of a vehicle includes emitting a radar signal using a radar sensor of the vehicle, receiving the radar signal reflected in the surroundings by way of the radar sensor, detecting objects in the surroundings based on the received radar signal, receiving surroundings signals from the surroundings using the radar sensor, checking the presence of a third-party radar signal from a third-party radar sensor of another road user in the surroundings signals, and assuming that there is an object in the surroundings that is not detected at present for the radar sensor based on the radar signal if the third-party radar signal is present.

### BACKGROUND AND SUMMARY OF THE INVENTION

The present invention relates to a method for detecting the surroundings of a vehicle. In addition, the present invention relates to a radar sensor system for a vehicle.

Currently, radar sensors are used in the automotive sector which emit a radar signal, receive the reflection of this radar signal at an object or obstacle in the surroundings of the vehicle, and evaluate the received radar signal accordingly. The determination of the signal duration, the frequency or the frequency shift, the spatial phase and/or amplitude conditions of the received radar signal, the distance, direction and relative speed can be determined instantaneously.

The detection of small objects at greater distances from a radar technology point of view poses a challenge because the energy of the emitted radar signal reflected back is very low and, depending on the actual conditions, it does not stand out from the noise or does so only very slightly. Radar sensors which are concealed behind vehicle components, in particular, reach their limits for smaller objects, such as motorcycles. On the one hand, these objects have a low backscatter cross-section. On the other hand, a large part of the transmitted and received radar energy is lost in the case of concealed installation. This can also be abetted by painting, for example with metallic paint, of the vehicle component. Furthermore, the distances to be measured are greatest from a requirements point of view for fast objects on a potential collision course, such as motorcycles. This may be the case, for example, if such a poorly detectable object approaches at a high speed in the adjacent lane and a lane change of the vehicle to this lane is planned. In this case, there is a short collision time and the free space attenuation or the attenuation of the radar signal is also very significant.

In addition, radar sensors for vehicles are known from the prior art, which can be used to determine the position or the lateral position of objects by way of multilateration. For example, ultra-wideband short-range radar sensors are known, which have been used in adaptive cruise control.

It is the object of the present invention to reveal a solution as to how the surroundings of a vehicle can be detected more reliably on the basis of measurements from a radar sensor.

This object is achieved according to the invention by a method as well as by a radar sensor system with the characteristics according to the claims.

A method according to embodiments of the invention is used to detect the surroundings of a vehicle. The method includes emitting a radar signal with a radar sensor of the vehicle. In addition, the method includes receiving the radar signal reflected in the surroundings by way of the radar sensor. In addition, the method includes the detection of objects in the surroundings on the basis of the received radar signal. In addition, the method includes the reception of surroundings signals from the surroundings with the radar sensor. The method also includes checking for the presence of a third-party radar signal from a third-party radar sensor of another road user in the surroundings signals, as well as the assumption that an object that is currently not detected by the radar sensor on the basis of the radar signal is present in the surroundings if the third-party radar signal is present.

The method is intended to identify objects or obstacles in the surroundings of the vehicle. The method can be carried out with an appropriate radar sensor system of the vehicle that has at least one radar sensor. This radar sensor is used to emit the radar signal. In addition, the radar sensor is used to detect the radar signal reflected in the surroundings or at objects in the surroundings. On the basis of the reflected radar signal or a received signal which describes the received radar signal, objects in the surroundings can then be detected. On the basis of the signal propagation time between the emission of the radar signal and the reception of the radar signal reflected at an object, the distance between the radar sensor and the object can be determined.

In addition, a frequency or frequency shift between the emitted and the received radar signal, a relative speed or relative radial speed between the vehicle and the object can be determined.

In addition, an angle between the vehicle and the object can be determined. This angle can be determined both in the azimuth direction and in the elevation direction.

According to embodiments of the invention, it is also provided that the radar sensor is used to receive the surroundings signals. For this purpose, the radar sensor can be operated in a corresponding reception mode for the reception of the surroundings signals. In this reception mode, the radar sensor can be used to detect all signals from the surroundings. The radar sensor can “listen” in the reception mode, so to speak.

In addition, it is checked whether the third-party radar signals which originate from third-party radar sensors are present in the surroundings signals. These third-party radar sensors are not associated with the subject vehicle, but with other road users in the surroundings of the vehicle.

For example, the surroundings signals can be received with the radar sensor in a frequency range that is typical for radar signals in the vehicle sector. Preferably, the radar sensor can be used to receive surroundings signals in a frequency range of 24 GHz and/or in a frequency range between 76 GHz and 81 GHz. In the reception mode, the surroundings signals in the predetermined frequency range can be received by the radar sensor for a predetermined duration. It can then be checked whether a third-party radar signal or a radar signal from another road user is present in these surroundings signals. If such a third-party radar signal is identified, it can be assumed or determined that there is another object in the surroundings of the vehicle, which has not or not yet been identified with the radar sensor on the basis of its own radar signal.

In the present case, it is taken into account that the received radar power of an object reflection decreases significantly with distance. A doubling of the distance thus requires significantly more power to still have the same amount of energy available for detection. If the distance becomes too large and the receiving energy falls below a critical threshold, the object can no longer be detected with the radar sensor. Conversely, when the distance to the object is reduced, more power is available. An essential idea of the present invention is to detect the radar radiation of other road users or the third-party radar sensors that are located closer to the object that has not yet been detected. With the method, even small objects and/or objects at a great distance can be detected. This is especially true for concealed built-in radar sensors and especially for short-range radar sensors with a large horizontal and/or vertical aperture angle, where only a little energy is available for successful detection of the reflection. Overall, the surroundings of the vehicle can be detected more reliably by taking into account the third-party radar signals.

According to one embodiment, it is assumed that the third-party radar signal is reflected at the object that is currently not detected on the basis of the radar signal or that the radar signal is emitted by the object itself that is currently not detected on the basis of the radar signal. For example, it may be the case that the third-party radar signal is emitted by another road user, for example another vehicle, and is reflected at the object that has not yet been detected and is then received by the radar sensor of the subject vehicle. It may also be the configuration that the third-party radar signal is emitted by the object itself that has not yet been detected.

For example, this undetected object may not have been detected due to the backscatter cross-section of the radar sensor of the subject vehicle or other effects. These different configuration can be taken into account when assuming that the object that has not yet been detected on the basis of the radar signal is in located the surroundings.

In one embodiment, the third-party radar signal in the surroundings signals is identified on the basis of a time profile and/or on the basis of a spectrum. As previously explained, the radar sensor can be used to receive the surroundings signals in a defined frequency range. Since in the frequency ranges used, only radars of vehicles using automotive applications or, where appropriate, radars for traffic monitoring may be used, it can be assumed that there is a high probability of another vehicle, but in any case an obstacle, being present when receiving third-party radar signals. In the surroundings signals, the third-party radar signals can be detected on the basis of their time profile or signal shape. Here, it is taken into account that radar sensors for automobile applications have a typical signal shape. Alternatively or additionally, these third-party radar signals can also be detected on the basis of their frequency spectrum. For example, the third-party radar signals can be frequency-modulated signals. In this case, provision may be made for the surroundings signals to be sampled first and then investigated regarding the time profile and/or the frequency. This allows third-party radar signals to be detected in a reliable manner.

According to a further embodiment, the surroundings signals are mixed with a predetermined reference signal to identify the third-party radar signal. This reference signal can describe a typical radar signal used in the automotive sector. The reference signal can also describe the radar signal that is emitted by the radar sensor itself. The surroundings signals can be mixed with this reference signal so that third-party radar signals that have the same or at least a similar signal shape as the reference signal can be detected. When the third-party radar signal is mixed with the reference signal, typical interferences may arise that indicate the presence of third-party radar signals. Basically, several or different reference signals may also be used to mix the surroundings signals. This makes it easy to check whether a third-party radar signal is present in the surroundings signals.

Furthermore, it is advantageous if the radar sensor can also be used to determine the reception direction of the existing third-party radar signal and to estimate an angular range in which the object that is not detected at present on the basis of the radar signal is located. The reception direction comes from the direction of the object that has not yet been detected and can therefore be evaluated directly. The reception direction of the third-party radar signal can be determined in the same way as the reception direction of the radar signal during normal operation of the radar sensor. For example, the reception direction of the third-party radar signal can be determined by evaluating amplitudes and/or phases of the third-party radar signal. The angular range can be determined at least in the azimuth direction. It may also be provided that the angular range is also determined with regard to the elevation direction. However, the distance to the object that is not detected at present is not easily detected since there is no synchronization with the original waveform of the third-party radar signal and the position and speed of the third-party radar sensor are not known. By defining the angular range, false positive measurements, which are caused by reflections at the infrastructure, for example, can be minimized, as these are outside the user's own travel path.

Furthermore, it is advantageous if a control signal is output to suppress a movement of the vehicle in the estimated angular range. On the basis of the assumption that there is an object in the surroundings that has not yet been detected on the basis of the radar signal, driver assistance functions of the vehicle can be controlled. As described above, the distance to the object that has not yet been detected cannot be determined directly on the basis of the third-party radar signal. However, the distance is not relevant in a first step, since the knowledge of the direction or the angular range alone of the object that has not yet been detected can be advantageously used for most driver assistance functions or driving strategy algorithms that use the radar sensor data. The assumption that a previously undetected object is present in the surroundings can be used for driving strategy algorithms for at least partially automated driving. If it is assumed that a previously undetected object is present in the surroundings and the angular range has been estimated for this object, driving maneuvers in which the vehicle is maneuvered in the angular range can be prevented. For example, a lane change to a lane that is associated with the angular range can be prevented. Thus, safe operation of the vehicle can be ensured on the basis of the measurements of the radar sensor.

In another embodiment, it is also checked whether an object detected on the basis of the radar signal is present in the estimated angular range. The question of whether the affected angular range up to an object detected by the radar sensor can be used for the vehicle can be determined on the basis of the assumption that an object that has not yet been detected has been detected on the basis of the third-party radar signals. This is only in the event that no object is detected in the angular range from which the third-party radar signals were received, this angular range can be taken into account separately for the driving function. For example, an offer of an automated lane change can be omitted. Even if it is assumed that the third-party radar signal is emitted by the object itself that has not yet been detected, the separate treatment of the angular range can be used in the driving function. If, for example, it is assumed that there is an object or vehicle somewhere in a lane, which has not yet been detected, this lane cannot be used until the object is actually detected on the basis of the radar signals. It may also be the case, for example, that a small object is not detected on the basis of the radar signal. In the same angular range, however, there is a larger or easily detectable object, which is detected on the basis of the radar signal. Here it was possible, with an appropriate functional design, to release the angular range up to the object detected on the basis of the radar signal, even though a small object or an object that has not yet been detected is potentially in the action area of the function. In order to minimize incorrect system actions, the third-party radar signal from the angular range can now still be used to perform probability-based actions.

In another embodiment, the sensitivity of the radar sensor for the estimated angular range is increased. When third-party radar signals are received and if an angular range is defined in which there is an object that has not yet been detected on the basis of the radar signal, the sensitivity of the radar sensor for this angular range can be increased in a subsequent measurement. For example, the transmission power of the emitted radar signal can be increased for this angular range. In this way, it is possible to ensure that the suspected object that has not yet been detected on the basis of the radar signal is actually detected with the radar sensor. Alternatively or additionally, it may be provided that the object not yet detected by the radar signal is detected with other environmental sensors of the vehicle. The sensitivity for the angular range can also be increased with these other environmental sensors. In this way, the reliability of the object detection can be increased.

In another embodiment, the surroundings signals are received during a transmission pause of the radar sensor, during which the radar signal is not emitted. With its own radar sensor, for example, the time ranges can be used in which no radar signal is emitted. These transmission pauses typically take up more than half of the time of a corresponding measurement cycle. During these transmission pauses, the radar sensor can “listen” accordingly and receive the surroundings signals. Since the third-party radar signal is a priori unknown, appropriate buffers or intermediate memories can also be used in which the surroundings signals are first stored and then checked for the presence of the third-party radar signal.

A radar sensor system according to embodiments of the invention for a vehicle comprises a radar sensor for emitting a radar signal and for receiving the radar signal reflected in the surroundings.

Furthermore, the radar sensor system includes a computing device for detecting objects in the surroundings on the basis of the received radar signal. In addition, the radar sensor is set up to receive surroundings signals from the surroundings. The computing device is also set up to detect the presence of a third-party radar signal from a third-party radar sensor of another road user in the surroundings signals and to make the assumption that an object that is not detected at present on the basis of the radar signals is present in the surroundings if the third-party radar signal is present.

By way of the computing device, the radar sensor can be used to emit the radar signal.

In addition, the received radar signal or a received signal describing the received radar signal can be transmitted to the radar sensor. The radar sensor system may have an appropriate mixer with which the received radar signal is mixed with a reference signal describing the emitted radar signal. Furthermore, the radar sensor system may have an analog-to-digital converter to sample the mixed signal. For receiving the surroundings signals, the surroundings signals can be fed directly to the analog-to-digital converter. Alternatively, it may be provided that the surroundings signals are mixed with a predetermined reference signal and then sampled. For the detection of surroundings signals or third-party radar signals, the existing components, such as receivers or receiving antennas, amplifiers, mixers, analog-to-digital converters, can be at least partially used. It may also be provided that additional components are used in order to detect the surroundings signals or third-party radar signals.

Another aspect of the invention relates to a computer program, comprising instructions which, when executed by a computing device, cause it to carry out the method according to embodiments of the invention or parts thereof. Furthermore, the invention relates to a computer-readable (storage) medium comprising instructions which, when executed by a computing device, cause it to carry out the method according to embodiments of the invention or parts thereof.

A vehicle according to embodiments of the invention comprises a radar sensor system according to embodiments of the invention. In particular, the vehicle may be in the form of a passenger car.

The preferred embodiments presented with reference to the method according to the invention and their advantages apply mutatis mutandis to the radar sensor system according to the embodiments of invention, to the computer program according to embodiments of the invention, to the computer-readable (storage) medium according to embodiments of the invention and to the vehicle according to embodiments of the invention.

Further features of embodiments of the invention result from the claims, the figures and the figure description. The features and combinations of features mentioned above in the description, as well as the features and combinations of features mentioned below in the description of the figures and/or shown in the figures alone, are not only able to be used in the combination given in each case, but also in other combinations or on their own without departing from the scope of the invention.

The invention will now be explained in more detail on the basis of preferred exemplary embodiments as well as by reference to the attached drawings.

### BRIEF DESCRIPTION OF THE DRAWINGS

FIG. 1 shows a vehicle that has a radar sensor system with a radar sensor.

FIG. 2 shows the vehicle in a traffic situation in which there is an object detected by the radar sensor and an object not detected by the radar sensor in the surroundings of the vehicle, wherein the object emits third-party radar beams which are reflected by the undetected object and received by the radar sensor. FIG. 3 shows another traffic situation in which third-party radar signals are reflected at the undetected object and third-party radar signals are even emitted by the undetected object.

FIG. 4 shows another traffic situation in which there is an object in the surroundings of the vehicle that is not detected on the basis of the radar signals of the radar sensor and that emits third-party radar signals.

FIG. 5 shows another traffic situation in which there is an object in the surroundings of the vehicle that is detected on the basis of the radar signals of the radar sensor and an undetected object, wherein third-party radar signals are emitted by another object and reflected at the undetected object.

### DETAILED DESCRIPTION OF THE DRAWINGS

In the figures, identical or functionally identical elements are provided with the same reference signs.

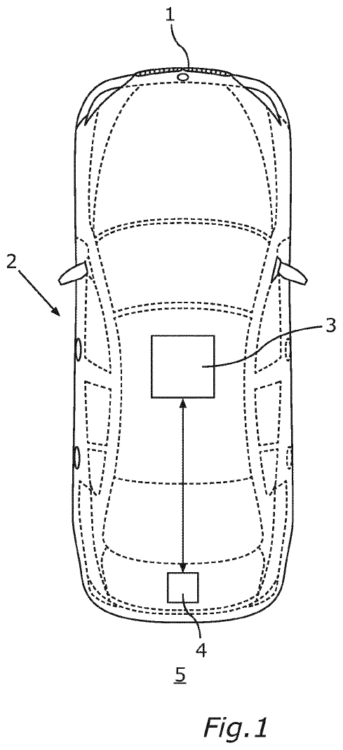

FIG. 1 shows in a schematic representation in a top view of a vehicle 1 which is in the form of a passenger car in the present case. The vehicle 1 comprises a radar sensor system 2, which in turn has a radar sensor 4. In principle, the radar sensor system 2 can have several radar sensors 4. Furthermore, the radar sensor system 2 contains a computing device 3, which may be formed by an electronic control unit, for example. The computing device 3 is connected to the radar sensor 4 for data transmission.

By way of the computing device 3, the radar sensor 4 can be controlled to emit a radar signal. The radar sensor 4 can then be used to receive the radar signal reflected in the surroundings 5 of the vehicle 1 again. Here, the received radar signal can be mixed with a reference signal, which describes the emitted radar signal. Subsequently, the mixed signal can then be sampled accordingly with an analog-to-digital converter and transmitted to the computing device 3. On the basis of the sampled signal, 3 objects 6 in the surroundings 5 of the vehicle 1 can then be detected by way of the computing device.

In the present case, it is also provided that the radar sensor 4 will receive third-party radar signals which are emitted by other road users 7. For this purpose, the radar sensor 4 can receive surroundings signals from the surroundings 5 during corresponding transmission pauses, during which the radar signal is not emitted. These surroundings signals can be received in a defined frequency range, which is typical for radar signals in the automotive sector. Furthermore, the surroundings signals can be examined for the presence of third-party radar signals. For this purpose, the surroundings signals can be sampled accordingly and examined by way of the computing device 3. Alternatively, the surroundings signals can be mixed with at least one reference signal, which describes a typical radar signal for the automotive sector, and then sampled.

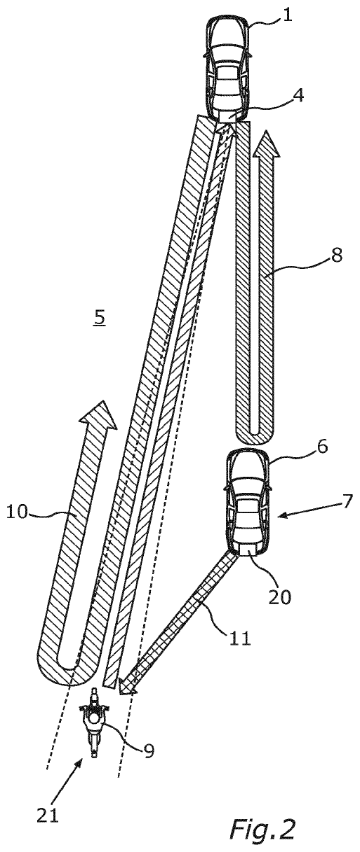

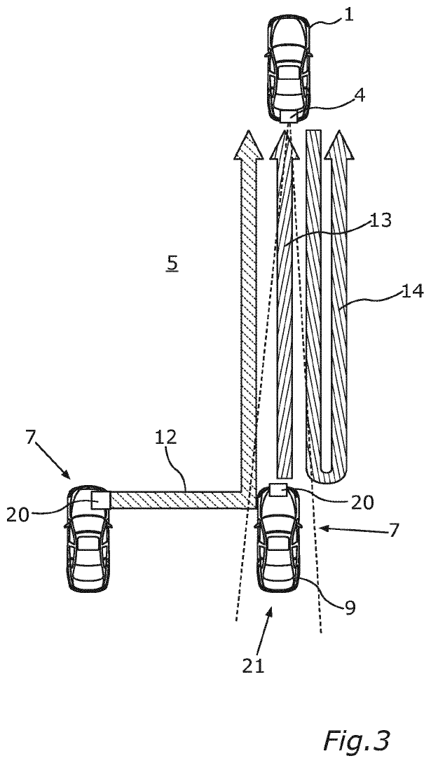

FIG. 2 shows a schematic representation of a first traffic situation. Here, there is an object 6 in the surroundings 5 of the vehicle 1 that can be detected on the basis of the radar signal of the radar sensor 4. In this case, the emitted radar signal is reflected by the object 6 and received again by the radar sensor 4. This is schematically indicated in the present case by the arrow 8. The object 6 is another vehicle. In addition, in the surroundings 5 of the vehicle 1 there is another object 9 in the form of a motorcycle, which cannot be detected on the basis of the measurements with the radar sensor 4.

The received radar power of the radar signal which is emitted with the radar sensor 4 decreases in total over the transmission path and the reception path with 1/R 4, where R is the distance. Doubling the distance between the radar sensor 4 and the other object 9 thus requires 12 dB more power in order to still have the same energy available for detection. In the present case, the distance between the vehicle 1 and the other object 9 is so large that the receiving energy falls below a critical threshold and thus the other object 9 can no longer be detected. This is illustrated in the present case by the arrow 10. Conversely, if the distance to the object is halved, 12 dB more power is available for detection.

The core idea is to use the third-party radar signal of another road user 7 which is closer to the other object 9 than the vehicle 1 itself. In the present case, the reflection of the third-party radar signal, which is emitted by a third-party radar sensor 20, at the further object 9 is used. The course of the third-party radar signal is illustrated in the present case by the arrow 11. This third-party radar signal can be detected with the radar sensor 4 of the subject vehicle 1. In addition, the reception direction of the third-party radar signal can be determined by way of the radar sensor 4. In this way, an angular range in which the further object exists can be defined. This means, for example, that corresponding driver assistance functions or driving strategy algorithms can be controlled in such a way that the vehicle 1 is not maneuvered in this angular range.

FIG. 3 shows another traffic situation in which there is another object 9 in the surroundings 5 of the vehicle 1. In addition, there is another road user 7 in the surroundings 5, with which a third-party radar signal is emitted. For further processing of the driving functions described above, it is important to distinguish whether the third-party radar signal is received which is reflected at another object. This is illustrated in the present case by the arrow 12. It may also be envisaged that the further object 9 emits the third-party radar signal itself. This is illustrated in the present case by the arrow 13. In the present case, it is checked whether the other object 9 can be detected by way of the radar sensor 4 of the vehicle 1. This is represented in the present case by the arrow 14. Only in the event that no object is detected by way of the radar sensor 4 in the angular range from which the third-party radar signal is received, is this angular range taken into account separately for the driving function.

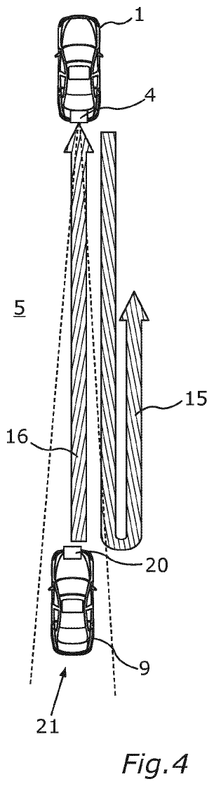

FIG. 4 shows another traffic situation in which there is another object 9 in the surroundings 5 of the vehicle 1. This object 9 is not even detectable due to the backscatter cross-section of the radar sensor 4 of the vehicle 1. This is illustrated in the present case by the arrow 15. In the example, however, the third-party radar signal is emitted by this additional object 9 itself (arrow 16). This third-party radar signal is received by the radar sensor 4 of the vehicle 1. Here, too, there is separate treatment of the angular range for the driving function. For example, it is assumed that somewhere in the angular range or in a lane of the angular range there is another object 9 that has not yet been detected. In this case, for example, no action may be carried out that affects this lane or the angular range before the other object 9 has actually been detected by way of the radar sensor 4.

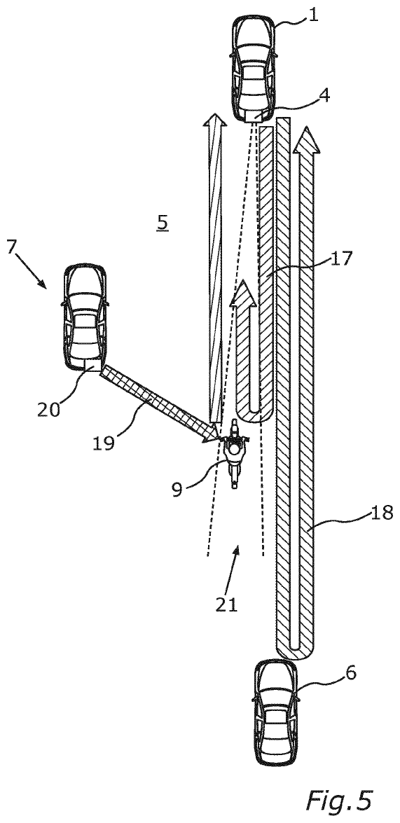

FIG. 5 shows another traffic situation in a schematic illustration in which there is another object 9 in the surroundings 5 of the vehicle 1 which cannot be detected on the basis of the radar signal of the radar sensor 4. This is illustrated in the present case by the arrow 17. There is an object 6 that can be detected with the radar sensor 4 in the same angular range behind this further object 9. The course of the radar signal is illustrated in the present case by the arrow 18. In addition, there is another road user 7 in the surroundings 5 of the vehicle 1, by which a third-party radar signal is emitted, which is reflected at the other object 9 and which is received by the radar sensor 4 of the subject vehicle 1 (arrow 19). Thus, it can be assumed that there is another object 9 in the angular range, which has not yet been detected with the radar sensor 4. In order to avoid false system actions, the signal of the third-party radar sensor 20 from the angular range can now still be used to perform probability-based actions. In addition, for example, the radar energy of the radar sensor 4 can be adjusted for this angular range to increase the probability of detection.

1.-10. (canceled)

11. A method for detecting surroundings of a vehicle, the method comprising:
emitting a radar signal by a radar sensor of the vehicle;
receiving the radar signal reflected in the surroundings by the radar sensor;
detecting objects in the surroundings based on the received radar signal;
receiving surroundings signals from the surroundings by the radar sensor;
checking for a presence of a third-party radar signal from a third-party radar sensor of another road user in the surroundings signals; and
assuming that an object that is not detected at present by the radar sensor based on the radar signal is present in the surroundings if the third-party radar signal is present.

12. The method according to claim 11, wherein:
it is assumed that the third-party radar signal is reflected by the object that is not detected at present based on the radar signal or that the third-party radar signal is emitted by the object that is not detected at present based on the radar signal.

13. The method according to claim 11, wherein:
the third-party radar signal in the surroundings signals is identified based on at least one of a time profile or a spectrum.

14. The method according to claim 11, wherein:
the surroundings signals are mixed with a predetermined reference signal to identify the third-party radar signal.

15. The method according to claim 11, further comprising:
determining a reception direction of the third-party radar signal by the radar sensor; and
estimating an angular range in which the object is located that is not detected at present based on the radar signal.

16. The method according to claim 15, further comprising:
outputting a control signal for suppressing a movement of the vehicle in the estimated angular range.

17. The method according to claim 15, further comprising:
checking whether the object that was detected based on the radar signal is present in the estimated angular range.

18. The method according to claim 15, further comprising:
increasing a sensitivity of the radar sensor for the estimated angular range.

19. The method according to claim 11, wherein:
the surroundings signals are received during a transmission pause of the radar sensor, during which emission of the radar signal is not carried out.

20. A radar sensor system for a vehicle, the radar sensor system comprising:
a radar sensor for emitting a radar signal and for receiving the radar signal reflected in surroundings of the vehicle; and
a processor for detecting objects in the surroundings based on the received radar signal, wherein:
the radar sensor is configured to receive surroundings signals from the surroundings, and
the computing device is configured to check for a presence of a third-party radar signal from a third-party radar sensor of another road user in the surroundings signals and to make an assumption that an object that is not detected at present by the radar sensor based on the radar signal is present in the surroundings if the third-party radar signal is present.
